(19) United States
(12) Patent Application Publication
(10) Pub. No.: US 2012/0210698 A1
(43) Pub. Date: Aug. 23, 2012

(54) METHOD AND DEVICE FOR DETERMINING THE CONVERSION CAPACITY OF A CATALYTIC CONVERTER FOR CLEANING EXHAUST GAS

(75) Inventors: Klaus Winkler, Rutesheim (DE); Ingmar Burak, Stuttgart (DE)

(73) Assignee: ROBERT BOSCH GMBH, Stuttgart (DE)

(21) Appl. No.: 13/400,234

(22) Filed: Feb. 20, 2012

(30) Foreign Application Priority Data
Feb. 18, 2011 (DE) 10 2011 004 380.2

(51) Int. Cl. F01N 11/00; G01M 15/10; F01N 3/20

(52) U.S. Cl. 60/274; 73/114.75

(57) ABSTRACT

A method for assessing the conversion capacity of a catalytic converter for hydrocarbons when cold starting an internal combustion engine by means of an exhaust probe arranged behind the catalytic converter in the direction of flow, wherein an output signal from the exhaust probe is fed to a control unit.

### BACKGROUND OF THE INVENTION

The invention relates to a method for assessing the conversion capacity of a catalytic converter for hydrocarbons when cold starting an internal combustion engine by means of an exhaust probe arranged behind the catalytic converter in the direction of flow, wherein an output signal from the exhaust probe is fed to a control unit.

The invention furthermore relates to a device for carrying out the method.

To reduce emissions from spark ignition engines, the general practice is to use three-way catalytic converters. The conversion capacity of the catalytic converters depends primarily on the temperature thereof. In order to meet legal requirements, the catalytic converters are therefore subjected to additional heating in order to achieve rapid readiness for operation in the case of cold starting. In order to comply with exhaust emissions limits, even in the case of relatively old catalytic converters, the conversion capacity of which may already be reduced, the heating measures are continued up to temperatures at which conversion will reliably begin even in the case of a relatively old catalytic converter. The heating phase is thus longer than is required for a new catalytic converter and, as a result, the latter will assume a higher temperature than is required. This can lead to those parts of the catalytic converter which face the internal combustion engine being subject to more severe aging owing to the high temperatures or temperature gradients. The aging of catalytic converters caused by poisoning or high temperatures generally occurs in a rearward direction in the direction of the exhaust, from the side facing the internal combustion engine. The heating measures for an aged catalytic converter are thus configured in such a way that not only the forward part thereof but a large part of the catalytic converter is heated up. Shortening the catalytic converter preheating phase for a new catalytic converter could therefore extend its life and would also reduce the emissions and fuel consumption of the internal combustion engine.

According to the prior art, the conversion capacity of a catalytic converter for hydrocarbons is rated indirectly at the operating temperature by means of its capacity for storing oxygen. Here, the capacity for storing oxygen is used as a measure for aging of the catalytic converter. These methods employ one oxygen sensor in front of the catalytic converter and one behind it. In this case, the mixture fed to the internal combustion engine is adjusted from rich to lean in order to store oxygen in the catalytic converter. By means of the output signals from the oxygen sensors and a knowledge of the volume of exhaust gas, it is thus possible to determine the oxygen storage capacity of the catalytic converter. Such a test is generally carried out in part-load operation and hence while the catalytic converter is at operating temperature.

DE 4112478C2 has disclosed a method for assessing the state of aging of a catalytic converter to which the exhaust gas from a combustion engine subject to closed-loop lambda control is fed and where the lambda values in front of and behind the catalytic converter are measured, a check is made to determine whether a fluctuation in the lambda value from rich to lean or vice versa in front of the catalytic converter is associated with a corresponding transition in the lambda value behind the catalytic converter and, if this is the case, the gas mass flow flowing through the catalytic converter is determined, the time integral of the product of the gas mass flow and the lambda value in front of the catalytic converter is calculated, the time integral of the product of the gas mass flow and the lambda value behind the catalytic converter is calculated, and either the difference between the two integrals or the quotient of the difference and one of the two integrals is used as a measure of the state of aging of the catalytic converter. In the method, a forced oscillation of predetermined frequency is impressed upon the lambda value.

One disadvantage with current methods and devices is that the conversion capacity of the catalytic converter for hydrocarbons is rated indirectly from the oxygen storage capacity thereof and only at the operating temperature, not in the phase shortly after cold starting. Another disadvantage is that a uniformly aged catalytic converter cannot be distinguished from a catalytic converter which has aged only in the region facing the internal combustion engine.

### SUMMARY OF THE INVENTION

It is therefore an object of the invention to provide a method which detects the conversion capacity of a catalytic converter for hydrocarbons even when cold starting.

It is furthermore an object of the invention to provide a corresponding device.

The object of the invention as it relates to the method is achieved by virtue of the fact that the hydrocarbon content of the exhaust gas is determined by means of the exhaust probe and that the beginning of conversion by the catalytic converter is inferred if there is a reduction in the proportion of hydrocarbons in the exhaust gas by a predetermined value. The exhaust probe arranged behind the catalytic converter is generally used to determine the oxygen content of the exhaust gas behind the catalytic converter. According to the invention, it is either additionally also sensitive to hydrocarbons, or an additional exhaust probe sensitive to hydrocarbons is used at this position. Catalytic converters may age uniformly over the entire length thereof or non-uniformly owing, for example, to overheating in the front region facing the internal combustion engine. In both cases, the oxygen storage capacity used to rate the conversion capacity may be the same even though the time profile of the beginning of conversion after cold starting of the internal combustion engine may be different. In the case of a catalytic converter which has aged in the front region, a larger portion of the catalytic converter must be heated before conversion begins. As a result, this begins with a delay in comparison with an as-new or uniformly aged catalytic converter. It is therefore advantageous, in accordance with the invention, to determine the hydrocarbon content of the exhaust gas and to infer the conversion capacity of the catalytic converter therefrom.

If measures for heating the catalytic converter in order to achieve readiness for operation thereof are ended as soon as the beginning of conversion by the catalytic converter is detected, it is possible to dispense with further heating in the case of a catalytic converter with a good conversion capacity, something that would mean an additional consumption of energy, and the thermal stress on the catalytic converter, which may cause additional aging, is reduced.

It is possible to achieve practically feasible rating of the conversion capacity of a catalytic converter if a criterion for diagnosis of the catalytic converter is formed from the time period between the starting of the internal combustion engine and the beginning of conversion by the catalytic converter or from the amount of heat introduced into the catalytic converter between the starting of the internal combustion engine and the beginning of conversion. In particular, it is possible for a catalytic converter with an aged front region to be adequately heated and to be distinguished from a uniformly aged catalytic converter. In this case, the conversion capacity can be rated solely on the basis of the emissions of hydrocarbons or in combination with the rating of the oxygen storage capacity of the catalytic converter.

The object of the invention as it relates to the device is achieved by virtue of the fact that the exhaust probe is designed as a hydrocarbon probe and that a circuit or a program sequence for rating the conversion capacity of the catalytic converter on the basis of the output signal from the exhaust probe is provided in the control unit. Designing the exhaust probe in accordance with the invention makes it possible to determine the conversion capacity of the catalytic converter directly and to dispense with indirect determination by way of the oxygen storage capacity thereof. The exhaust probe arranged behind the catalytic converter in the direction of flow of the exhaust gas can be a combined probe sensitive to oxygen and hydrocarbons, or can be an additional probe sensitive to hydrocarbons.

### BRIEF DESCRIPTION OF THE DRAWINGS

The invention is explained in greater detail below with reference to an embodiment illustrated in the figures, of which:

FIG. 1 shows a schematic representation of an internal combustion engine having a catalytic converter in an exhaust duct,

FIG. 2 shows a first time diagram of the profile of the emissions of hydrocarbons when cold starting, and

FIG. 3 shows a second time diagram of an output signal from an exhaust probe and of the emissions of hydrocarbons when cold starting.

### DETAILED DESCRIPTION

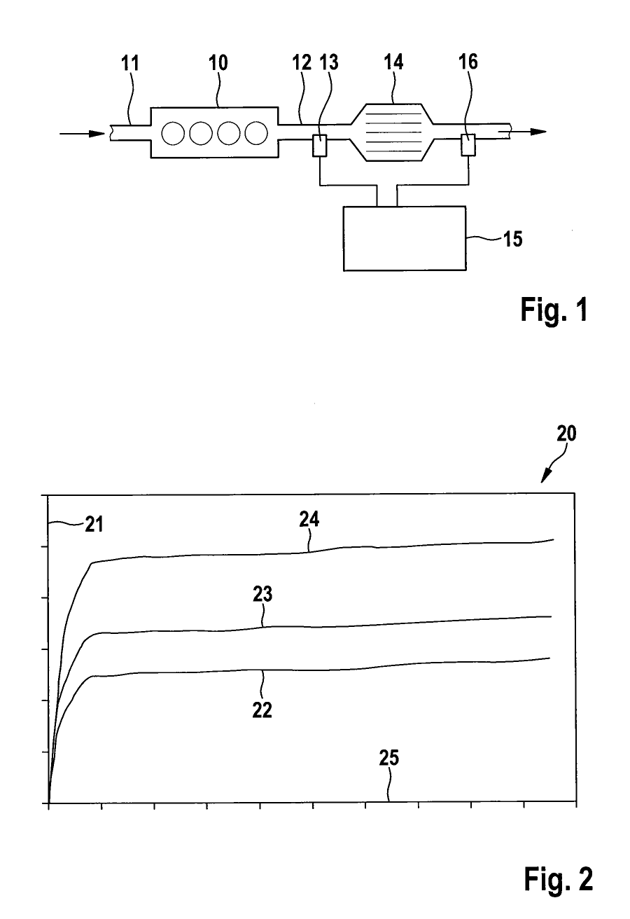

FIG. 1 shows an internal combustion engine 10 having an air feed 11 and a catalytic converter 14 arranged in an exhaust duct 12. An oxygen sensor 13 is provided in front of the catalytic converter 14 and an exhaust probe 16 is provided behind the catalytic converter 14 in the direction of flow of the exhaust gas. The output signal from the exhaust probe 16 is dependent on the hydrocarbon content of the exhaust gas and, like the output signal from the oxygen sensor 13, is fed to a control unit 15. During the operation of the internal combustion engine 10, the oxygen sensor 13 serves as a lambda sensor for monitoring the air/fuel ratio fed to the internal combustion engine. When the internal combustion engine 10 is cold started, an oxygen-rich mixture is generally fed in during a catalytic converter heating phase in order to raise the catalytic converter 14 to the operating temperature thereof and begin the conversion of unwanted constituents of the exhaust gas as rapidly as possible. Once conversion has begun, the exothermic reaction which then occurs leads to further heating of the catalytic converter until it reaches the operating temperature over the entire length thereof. According to the prior art, the heating phase of the catalytic converter is designed to be long enough to ensure that even a catalytic converter 14 which has already aged begins conversion. As a result, an as-new catalytic converter capable of beginning conversion early may be heated to a higher temperature than is absolutely necessary and, as a result, the catalytic coating may be subject to increased aging—especially in the region facing the internal combustion engine. If a drop in the hydrocarbon content of the exhaust gas is detected by means of the exhaust probe 16, then, according to the invention, the beginning of conversion is inferred and the heating phase of the catalytic converter is ended. This makes it possible to avoid increased aging of the catalytic converter 14 and to minimize energy consumption and the production of carbon dioxide when cold starting the internal combustion engine.

FIG. 2 shows a first time diagram 20, in which the cumulative hydrocarbon emissions behind the catalytic converter 14 of an internal combustion engine 10 are plotted along a first time axis 25 and a signal axis 21 for three different states of aging of the catalytic converter 14 when cold starting. A first quantity signal 22 shows the time profile of the cumulative hydrocarbon emissions after cold starting for a catalytic converter 14 with a good conversion capacity. The total quantity of hydrocarbons rises initially since the catalytic converter 14 is still cold. However, heating very soon has the effect that conversion begins and only a small quantity of hydrocarbons then leaves the catalytic converter, with the result that the first quantity signal 22, which indicates the total quantity of hydrocarbons emitted, then rises only slightly. A second quantity signal 23 shows the profile of the total quantity of hydrocarbons emitted when the catalytic converter 14 has aged uniformly over the entire length thereof. The aging of the catalytic converter has the effect that conversion starts later and, as a result, the second quantity signal 23 rises further than the first quantity signal 22.

The third quantity signal 24 shows the time profile of the total quantity of hydrocarbons emitted when that region of the catalytic converter which faces the internal combustion engine has aged severely but the oxygen storage capacity of the catalytic converter overall is just as high as in the second case considered. The conversion capacity of such a catalytic converter is placed in precisely the same category by prior art rating methods as a catalytic converter that was considered in the second case. In the second case, the catalytic converter heating phase leads to heating that begins in the part of the catalytic converter facing the internal combustion engine and starts conversion there. In the third case, however, the aging of the front region has the effect that conversion does not start there. This starts only when there is a sufficiently high temperature in a part of the catalytic converter situated further downstream. During the prolonged heating phase, the third quantity signal 24 therefore rises further and exceeds the second quantity signal 23.

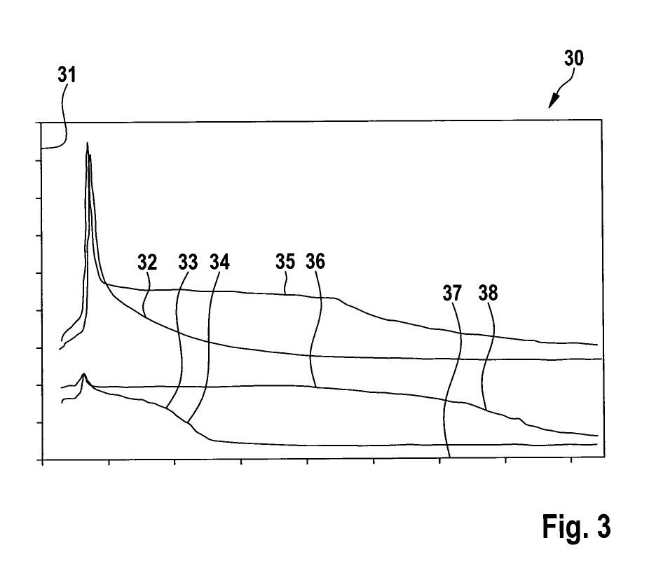

FIG. 3 shows a second time diagram 30, which shows the time profile of an output signal from an exhaust probe 16 sensitive to hydrocarbons and that of hydrocarbon emissions behind a catalytic converter 14, the signals being plotted along a second time axis 37 and a signal axis 31. If the catalytic converter 14 is in an as-new condition with a good conversion capacity, the first hydrocarbon emissions 32 initially rise and, after reaching a maximum value, fall rapidly due to the beginning of conversion by the catalytic converter 14. This behavior is reflected in a first sensor signal 33, the output signal from the exhaust probe. The first sensor signal 33 rises initially to a maximum value and then falls rapidly. Since the relationship between the first hydrocarbon emissions 32 and the first sensor signal 33 is not linear, the falls in the signals have a different shape.

If the catalytic converter 14 has already aged, second hydrocarbon emissions 35 occur after the starting of the internal combustion engine, and these remain at a higher level for longer than the first hydrocarbon emissions 32 before falling as the operating temperature of the catalytic converter 14 is reached. This behavior is reflected in a second sensor signal 36, which remains at a high level for longer than the first sensor signal 33. The beginning of conversion by the catalytic converter 14 can be inferred both from the first signal drop 34 of the first sensor signal 33 and from the second signal drop 38 of the second sensor signal 36. In both cases, the catalytic converter heating phase can be ended on the basis of this information. In the case of an as-new catalytic converter 14, it is possible to minimize the temperature stress on said converter and to prevent aging that might be caused by overheating. From the time profiles of the first sensor signal 33 and of the second sensor signal 36, in particular from the time taken from the starting of the internal combustion engine to the beginning of conversion indicated by the first signal drop 34 and the second signal drop 38, it is possible to derive statistics for the state of aging of the catalytic converter 14.

1. A method for assessing the conversion capacity of a catalytic converter (14) for hydrocarbons when cold starting an internal combustion engine (10) by means of an exhaust probe (16) arranged behind the catalytic converter (14) in a direction of flow, the method comprising feeding an output signal from the exhaust probe (14) to a control unit (15), determining the hydrocarbon content of the exhaust gas by means of the exhaust probe (16) and inferring the beginning of conversion by the catalytic converter (14) if there is a reduction in the proportion of hydrocarbons in the exhaust gas by a predetermined value.

2. The method according to claim 1, further comprising ending measures for heating the catalytic converter (14) in order to achieve readiness for operation as soon as the beginning of conversion by the catalytic converter (14) is detected.

3. The method according to claim 2, further comprising forming a criterion for diagnosis of the catalytic converter (14) from the time period between the starting of the internal combustion engine and the beginning of conversion by the catalytic converter (14) or from the amount of heat introduced into the catalytic converter (14) between the starting of the internal combustion engine and the beginning of conversion.

4. The method according to claim 1, further comprising forming a criterion for diagnosis of the catalytic converter (14) from the time period between the starting of the internal combustion engine and the beginning of conversion by the catalytic converter (14) or from the amount of heat introduced into the catalytic converter (14) between the starting of the internal combustion engine and the beginning of conversion.

5. A device for assessing the conversion capacity of a catalytic converter (14) for cleaning the exhaust gas of an internal combustion engine (10) by means of an exhaust probe (16) arranged behind the catalytic converter (14) in a direction of flow, the device comprising a control unit (15) for evaluating an output signal from the exhaust probe (14), wherein the exhaust probe (16) is a hydrocarbon probe, and the device also comprising, in the control unit, a circuit or a program sequence for rating the conversion capacity of the catalytic converter (14) on the basis of the output signal from the exhaust probe (16).
